(19) United States
(12) Patent Application Publication
(10) Pub. No.: US 2025/0249965 A1
(43) Pub. Date: Aug. 7, 2025

(54) METHOD OF MANUFACTURING VEHICLE-BODY STRUCTURAL COMPONENT AND VEHICLE-BODY STRUCTURAL COMPONENT

(71) Applicant: SUBARU CORPORATION, Tokyo (JP)

(72) Inventors: Hiroyasu ITO, Tokyo (JP); Masaharu NOGUCHI, Tokyo (JP)

(21) Appl. No.: 19/190,991

(22) Filed: Apr. 28, 2025

Related U.S. Application Data
(63) Continuation of application No. PCT/JP2023/034021, filed on Sep. 20, 2023.

(51) Int. Cl. B62D 29/04; B29C 70/84; B29L 31/30; B62D 21/15; B62D 21/16; B62D 25/02

(52) U.S. Cl. CPC B62D 29/046; B29C 70/84; B62D 21/157; B62D 21/16; B62D 25/025; B29L 2031/3055

(57) ABSTRACT

A method of manufacturing a vehicle-body structural component includes: forming a cylindrical molded body made of a fiber-reinforced resin by molding a continuous fiber impregnated with a thermoplastic resin into a cylindrical shape and curing the thermoplastic resin; disposing a component in a space on an inner peripheral side of the molded body; and heating at least a portion of the molded body to melt the thermoplastic resin while maintaining continuity of a fiber in an axial direction of the molded body and continuity of a fiber in a circumferential direction around an axis of the molded body, deforming the at least a portion of the melted molded body from an outer peripheral side toward the inner peripheral side of the molded body to form projections projecting toward the inner peripheral side so as to come into contact with the component, and then curing the thermoplastic resin again.

### CROSS-REFERENCE TO RELATED APPLICATIONS

This application is continuation of International Application No. PCT/JP2023/034021, filed on Sep. 20, 2023, the entire contents of which are hereby incorporated by reference.

### BACKGROUND

The disclosure relates to a method of manufacturing a vehicle-body structural component made of a fiber-reinforced resin and a vehicle-body structural component.

In recent years, for the purpose of reducing the weights of vehicle bodies of automobiles, such as cars, the use of a fiber-reinforced resin, a representative example of which is carbon fiber-reinforced resin (hereafter referred to as “CFRP”), for manufacturing structural members of vehicle bodies has been considered. A structural member made of a fiber-reinforced resin has high rigidity and exhibits high strength, particularly against compressive stress or tensile stress acting in the fiber orientation direction. For example, Japanese Unexamined Patent Application Publication No. 2020-062916 discloses a hollow structure frame that is made of a fiber-reinforced composite material and that is applicable to center pillars, side sills, and the like of a vehicle body structure.

### SUMMARY

An aspect of the disclosure provides a method of manufacturing a vehicle-body structural component. The method includes: forming a molded body that is made of a fiber-reinforced resin and that has a cylindrical shape by molding a continuous fiber impregnated with a thermoplastic resin into a cylindrical shape and curing the thermoplastic resin; disposing a predetermined component in a space on an inner peripheral side of the molded body, which has the cylindrical shape; and heating, while maintaining continuity of a fiber in an axial direction of the molded body and continuity of a fiber in a circumferential direction around an axis of the molded body, at least a portion of the molded body to melt the thermoplastic resin, deforming the at least a portion of the molded body that has been melted from an outer peripheral side of the molded body toward the inner peripheral side of the molded body to form projections that project toward the inner peripheral side so as to come into contact with the predetermined component, and then curing the thermoplastic resin again.

An aspect of the disclosure provides a method of manufacturing a vehicle-body structural component. The method includes: forming a molded body that is made of a fiber-reinforced resin and that has a cylindrical shape by molding a continuous fiber impregnated with a thermoplastic resin into a cylindrical shape and curing the thermoplastic resin; disposing a predetermined component in a space on an inner peripheral side of the molded body, which has the cylindrical shape; and heating at least a portion of the molded body to melt the thermoplastic resin, forming projections that project toward the inner peripheral side of the molded body so as to come into contact with the predetermined component, and then curing the thermoplastic resin again. The predetermined component is a heat exchanger or a hydrogen tank.

An aspect of the disclosure provides a vehicle-body structural component including a molded body and a predetermined component. The molded body is made of a fiber-reinforced resin and has a cylindrical shape. The predetermined component is disposed in a space inside the molded body. The molded body comprises projections provided on an inner peripheral surface of the molded body so as to come into contact with the predetermined component. The projections are configured to press and support the predetermined component. In the molded body, continuity of a fiber in an axial direction of the molded body and continuity of a fiber in a circumferential direction around an axis of the molded body are maintained.

An aspect of the disclosure provides a vehicle-body structural component including a molded body and a predetermined component. The molded body that is made of a fiber-reinforced resin and has a cylindrical shape. The predetermined component is disposed in a space inside the molded body. The molded body comprises projections provided on an inner peripheral surface of the molded body so as to come into contact with the predetermined component. The projections are configured to press and support the predetermined component. The predetermined component is a heat exchanger or a hydrogen tank.

### BRIEF DESCRIPTION OF THE DRAWINGS

The accompanying drawings are included to provide a further understanding of the disclosure and are incorporated in and constitute a part of this specification. The drawings illustrate embodiments and, together with the specification, serve to describe the principles of the disclosure.

FIG. 1 is a schematic diagram illustrating an overall configuration of a vehicle-body side structure according to an embodiment of the disclosure.

FIG. 2 is a perspective view illustrating a configuration of the side-sill structural component according to the present embodiment.

FIG. 3 is a cross-sectional view illustrating a cross section of the side-sill structural component illustrated in FIG. 2.

FIG. 4 is a cross-sectional view illustrating another cross section of the side-sill structural component illustrated in FIG. 2.

FIG. 5 is a horizontal cross-sectional view of a region of the side-sill structural component illustrated in FIG. 2.

FIG. 6 is a diagram illustrating a modification of the side-sill structural component according to the present embodiment.

FIG. 7 is a diagram illustrating a case in which recesses of the side-sill structural component according to the present embodiment are filled with a resin.

FIG. 8 is a diagram illustrating a case in which an outer peripheral surface of the side-sill structural component according to the present embodiment is provided with a fiber-reinforced resin layer.

FIG. 9 is a diagram illustrating the manufacturing method of the side sill according to the present embodiment.

### DETAILED DESCRIPTION

In the case where a structural member of a vehicle body made of a fiber-reinforced resin has a hollow structure, it is assumed that, if a predetermined component can be disposed in an internal space of the hollow structure, the space can be effectively used. For example, a fuel cell vehicle (FCV) that is equipped with a fuel cell serving as a power generator includes a secondary battery, a hydrogen tank, and so forth, and a space for mounting these components is necessary. For example, an electric automobile that is equipped with a turbine engine serving as a power generator includes a secondary battery, the turbine engine, a motor for power generation, a heat exchanger, and so forth, and a space for mounting these components is necessary. In contrast, in the case where a predetermined component is disposed in an internal space of a hollow structure, it is necessary to fix the component to a structural member.

For example, in the case of fixing it into place by using a bolt and a nut, when a hole into which the bolt is inserted is formed in the structural member made of a fiber-reinforced resin, there is a possibility that the fibers may be cut, reducing the strength of the structural member. In addition, in the case where the hole into which the bolt is inserted is formed during a manufacturing stage of the structural member, for example, the arrangement of the fibers is to be refined, which may complicate the manufacturing process.

It is desirable to provide a vehicle-body structural component in which a predetermined component can be easily fixed in place in an internal space of a hollow molded body made of a fiber-reinforced resin and in which a decrease in the strength of the molded body can be suppressed and a method of manufacturing a vehicle-body structural component capable of efficiently manufacturing such a vehicle-body structural component.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

### Vehicle-Body Structural Component

First, an outline of a vehicle-body structure including a vehicle-body structural component according to the present embodiment will be described.

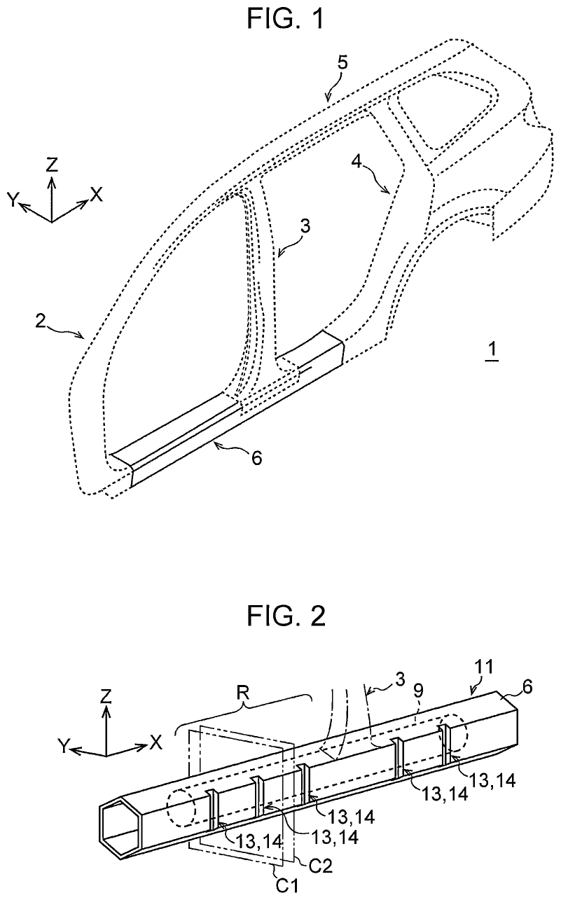

FIG. 1 is a schematic diagram illustrating an appearance of a vehicle-body side structure 1. FIG. 1 illustrating the vehicle-body side structure 1 schematically and partially illustrates the structure of a left side portion of a vehicle. Note that, in the present specification, the longitudinal direction of a vehicle body, a vehicle width direction, and the height direction of the vehicle body will sometimes be referred to as the X direction, the Y direction, and the Z direction, respectively, as illustrated in FIG. 1.

The vehicle-body side structure 1 includes a front pillar 2, a center pillar 3, a rear pillar 4, a roof pillar 5, a side sill 6, and so forth. The roof pillar 5 extends along the vehicle-body longitudinal direction at an upper portion of a space of a vehicle cabin of the vehicle and forms a side portion of a roof of the vehicle. The side sill 6 extends along the vehicle-body longitudinal direction at a lower portion of the side portion of the vehicle. In the present embodiment, the side sill 6 constitutes a portion of the vehicle-body structural component to which the technology of the disclosure is applied.

The front pillar 2 has a lower end coupled to a front end of the side sill 6 and an upper end coupled to a front end of the roof pillar 5. The front pillar 2 forms a front portion constituting the space of the vehicle cabin of the vehicle and is disposed so as to support a side of a windshield. The rear pillar 4 has a lower end coupled to a rear end of the side sill 6 and an upper end coupled to a rear end of the roof pillar 5. The center pillar 3 has a lower end coupled to a center portion of the side sill 6 in the vehicle-body longitudinal direction and an upper end coupled to a center portion of the roof pillar 5 in the vehicle-body longitudinal direction.

An opening for a front door is defined by the side sill 6, the roof pillar 5, the front pillar 2, and the center pillar 3. Another opening for a rear door is defined by the side sill 6, the roof pillar 5, the rear pillar 4, and the center pillar 3. Each of the structural components constituting the vehicle-body side structure 1 may be formed by combining a plurality of members.

Next, a configuration of a side-sill structural component 11 including the side sill 6 will be described in detail as the vehicle-body structural component according to the present embodiment.

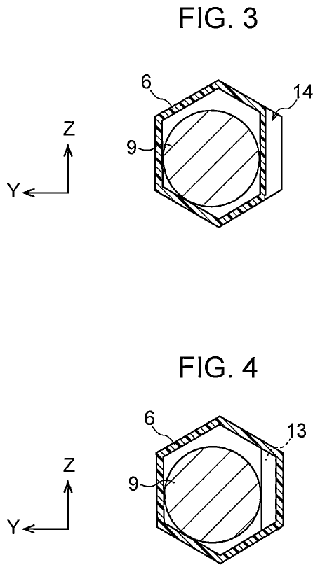

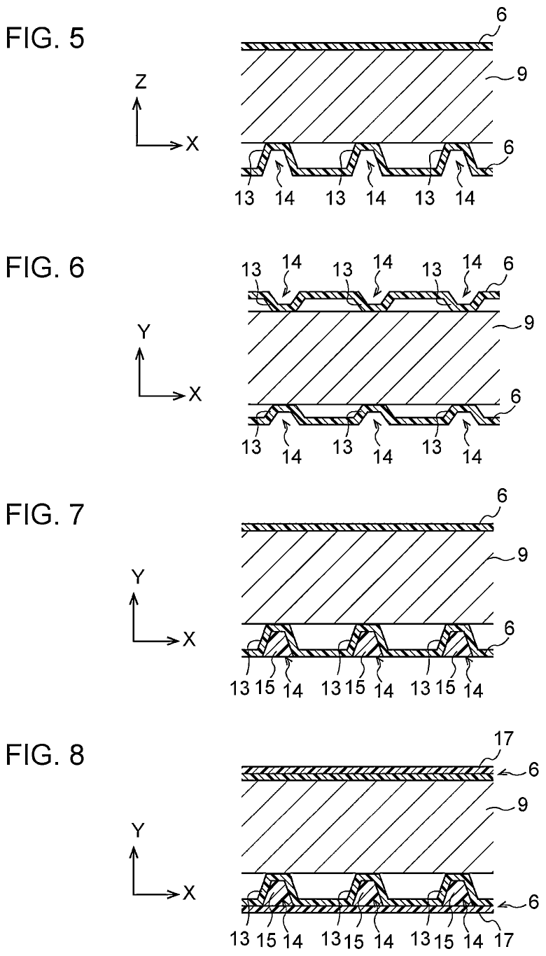

FIG. 2 to FIG. 5 are diagrams illustrating an example of the configuration of the side-sill structural component 11 according to the present embodiment. FIG. 2 is a front perspective view of the side-sill structural component 11 as viewed from the outside of the vehicle body in the vehicle width direction. FIG. 3 and FIG. 4 are respectively a cross-sectional view illustrating a cross section C1 of the side-sill structural component 11 illustrated in FIG. 2 and a cross-sectional view illustrating a cross section C2 of the side-sill structural component 11 and are cross-sectional views when the vehicle body is viewed from the front side toward the rear side. FIG. 5 is a sectional view illustrating a horizontal section (an X-Y plane) of a region R of the side-sill structural component 11 illustrated in FIG. 2.

The side-sill structural component 11 includes the side sill 6 having a cylindrical shape and a component 9 that is disposed in a space on the inner peripheral side of the side sill 6. The side sill 6 is a member that is made of a carbon fiber-reinforced resin and molded into a hollow cylindrical shape and that extends along the vehicle-body longitudinal direction. The side sill 6 illustrated in FIG. 2 is formed in a hexagonal columnar shape having a hexagonal cross section orthogonal to the vehicle-body longitudinal direction. The center pillar 3 extending upward is coupled to the center portion of the side sill 6 in an axial direction of the side sill 6.

The side sill 6 is molded by using a fiber-reinforced resin obtained by impregnating carbon fibers with a thermoplastic resin as a matrix resin.

Examples of the thermoplastic resin include a polyethylene resin, a polypropylene resin, a polyvinyl chloride resin, acrylonitrile-butadiene-styrene copolymer synthetic resin (ABS resin), a polystyrene resin, an acrylonitrile-styrene copolymer synthetic resin (AS resin), a polyamide resin, a polyacetal resin, a polycarbonate resin, a polyester resin, a polyphenylene sulfide (PPS) resin, a fluororesin, a polyetherimide resin, a polyether ketone resin, and a polyimide resin.

The thermoplastic resin may be one of the above-mentioned resins or a mixture of two or more of the above-mentioned resins. Alternatively, the thermoplastic resin may be a copolymer of the above-mentioned resins. In the case where the thermoplastic resin is a mixture, a compatibilizer may be further used in combination. In addition, a bromine-based flame retardant, a silicon-based flame retardant, red phosphorus, or the like may be added to the thermoplastic resin as a flame retardant.

The carbon fibers include continuous fibers oriented in the longitudinal direction of the side sill 6 and continuous fibers oriented in a direction crossing the longitudinal direction at an appropriate ratio. By adjusting the amount of the continuous fibers oriented in the longitudinal direction, a tensile stress that is generated when receiving a load due to a side collision can be adjusted. By adjusting the amount of the continuous fibers oriented in the direction crossing the longitudinal direction, the rigidity against the load received during the side collision is adjusted, and the energy absorption amount can be adjusted. In addition, the carbon fibers may include short fibers in addition to the continuous fibers and may include fibers other than the carbon fibers as reinforcement fibers.

The side sill 6 is a cylindrical molded body having a closed cross-sectional shape, and thus, the continuity of fibers can be maintained not only in the axial direction (longitudinal direction) thereof but also in the circumferential direction around its axis, so that the rigidity against the load received during the side collision can be improved.

The component 9 disposed in the space on the inner peripheral side of the side sill 6 is not particularly limited. For example, the vehicle to which the vehicle-body side structure 1 is applied may be an electric automobile that is equipped with a turbine engine generator, and the predetermined component 9 may be a heat exchanger. The heat exchanger is provided in order to cool a high-temperature exhaust gas discharged from the turbine engine. In other words, the component 9 is coupled to a pipe through which the exhaust gas is introduced, a pipe through which the exhaust gas is discharged, and a pipe in which a cooling water circulates (not illustrated).

The vehicle to which the vehicle-body side structure 1 is applied may be a fuel cell vehicle, and the predetermined component 9 may be a hydrogen tank. In other words, a pipe through which hydrogen is discharged (not illustrated) is coupled to the component 9. In any of the electric automobile and the fuel cell vehicle, which have been mentioned above, a region that is located on the inner side of the vehicle body in the vehicle width direction with respect to the side sill 6 is a region below a floor of the vehicle cabin, and a plurality of secondary batteries are disposed in this region.

The side sill 6 has projections 13 that are provided on one of the inner peripheral surfaces of the side sill 6 so as to come into contact with the component 9 and so as to support the component 9 by being pressed against it. In the present embodiment, recesses 14 are formed in one of the outer peripheral surfaces of the side sill 6, so that the projections 13 are formed on the inner peripheral surface of the side sill 6. The side sill 6 has the five projections 13 arranged along the vehicle-body longitudinal direction on a surface of the side sill 6 on the outer side of the vehicle body in the vehicle width direction. Each of the projections 13 extends along the vehicle-body height direction.

Each of the projections 13 is in contact with the component 9 and supports the component 9 by pressing the component 9 against one of the inner peripheral surfaces of the side sill 6, the inner peripheral surface being located on the inner side of the vehicle body in the vehicle width direction. As will be described later, the component 9 is disposed in a space on the inner peripheral side of a molded body 6a that has been molded once, but not yet become the side sill 6, and then the recesses 14 are formed in the outer peripheral surface of the side sill 6, so that the projections 13 are formed. Thus, each of the projections 13 and the component 9 are in contact with each other without a gap therebetween.

In order to reliably support the component 9 by using the projections 13, it is necessary to provide at least one projection 13 on each of the front and rear sides of the vehicle body with respect to the component 9. Other than that, the number of the projections 13 and the positions of the projections 13 are not limited. In addition, each of the projections 13 may have a shape that is not a shape extending along the vehicle-body height direction. However, in the case where each of the projections 13 has a shape extending along the vehicle-body height direction, when the outer peripheral surface of the component 9 has a curved surface shape such as a cylindrical shape, the outer peripheral surface of the component 9 can be reliably pressed by each of the projections 13 even if the height position of the component 9 is shifted.

Even if each of the projections 13 does not have a shape extending along the vehicle-body height direction and the projections 13 are disposed along the vehicle-body height direction, the outer peripheral surface of the component 9 can be reliably pressed by any one or more of the projections 13.

In addition, the projections 13 are formed by deforming the molded body 6a of the side sill 6 made of the fiber-reinforced resin containing the continuous fibers, so that the orientation direction of the continuous fibers in a side surface portion of each of the projections 13 becomes parallel to the vehicle width direction. Thus, when a side collision of the vehicle occurs, at least the amount of energy absorbed by the side sill 6 when the side sill 6 receives a collision load can be increased. As a result, breakage of the components such as the secondary batteries that are disposed in the region below the floor of the vehicle cabin can be suppressed.

As illustrated in FIG. 6, the projections 13 may be provided on both the surface on the outer side of the vehicle body and the surface on the inner side of the vehicle body in the vehicle width direction. However, when the sum of the projections 13 in the vehicle width direction is the same, by providing the projections 13 only on the surface on the outer side of the vehicle body in the vehicle width direction, the height of each of the projections 13 becomes largest, and the energy absorption amount when a side collision occurs can be further increased.

As illustrated in FIG. 7, a resin 15 may be disposed in the recesses 14 each of which forms a corresponding one of the projections 13. By filling the recesses 14 with the resin 15, deterioration in the appearance due to formation of the plurality of projections 13 or a decrease in a joint strength when another member is further joined to the outer periphery of the side sill 6 can be prevented. From the standpoint of facilitating manufacture, the resin 15 may be the same type of thermoplastic resin as the matrix resin of the fiber-reinforced resin.

In addition, as illustrated in FIG. 8, in a state where the resin 15 is disposed in the recesses 14, a fiber-reinforced resin layer 17 that includes continuous fibers wrapped around the outer periphery of the side sill 6 may be further provided. As a result, a decrease in the strength of the entire side sill 6 can be suppressed.

One or more of the recesses 14 may be provided with, instead of the resin 15, an energy absorption member that has an energy absorbing function. The energy absorption member is crushed by receiving a collision load during a side collision and absorbs the collision load. For example, the energy absorption member is a composite material of a plurality of layers formed by using a carbon fiber-reinforced resin using a thermosetting resin or a thermoplastic resin and carbon fibers, and can realize high strength and weight reduction.

For example, the energy absorption member has a cylindrical shape. The energy absorption member made of the fiber-reinforced resin absorbs the collision load by being crushed while being sequentially broken from a tip end thereof when it receives the collision load. Sequential breakage occurs in the energy absorption member made of the fiber-reinforced resin at smaller intervals compared with a crash box made of a steel plate, and thus, a stable energy absorption characteristic with less load fluctuation can be achieved. In addition, the energy absorption member made of the fiber-reinforced resin has characteristics of relatively less residual deformation and a high amount of collision load absorption per unit weight.

The energy absorption member may include a tapered portion whose diameter decreases toward an end portion on the outer side of the vehicle body. By providing the tapered portion, when the collision load is transmitted to the tip end side of the energy absorption member, separation of layers forming the energy absorption member from each other is likely to occur. This separation acts as a trigger for the breakage on the tip end side of the energy absorption member, and the sequential breakage of the energy absorption member can easily occur. Note that the shape of the energy absorption member is not limited to a cylindrical shape, and various configurations can be employed.

### Method of Manufacturing Vehicle-Body Structural Component

Next, an example of the method of manufacturing the side-sill structural component 11 serving as the vehicle-body structural component according to the present embodiment will be described.

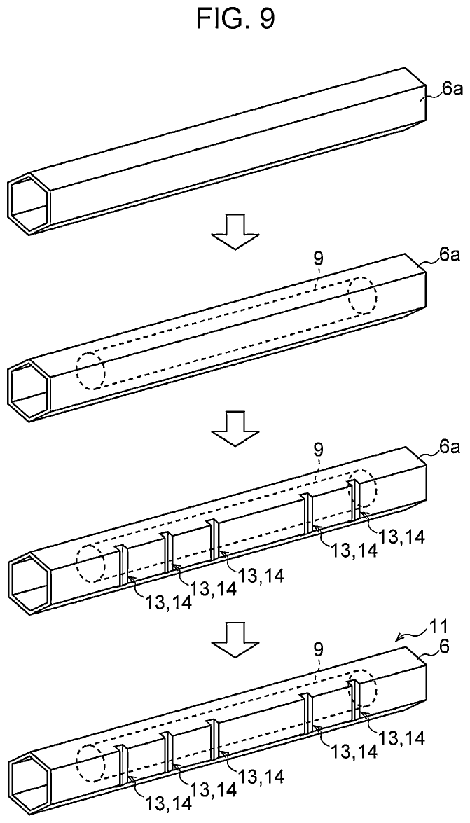

FIG. 9 is a diagram illustrating a process of manufacturing the side-sill structural component 11.

First, the molded body 6a that is made of the fiber-reinforced resin and that has a cylindrical shape is molded by a method of the related art such as a braiding method, a filament winding method, a sheet winding method, a lay-up method, cold press molding, or hot press molding (a first step). The method of molding the molded body 6a is not particularly limited. However, since the thermoplastic resin is used as the matrix resin, a method is employed in which the matrix resin is cooled in a state where the fiber-reinforced resin that is melted as a result of the matrix resin being heated is molded.

Next, the predetermined component 9 is positioned in the space on the inner peripheral side of the cylindrical molded body 6a (a second step). In this case, for example, the positioning of the predetermined component 9 may be performed by using a water-soluble positioning member. Although the water-soluble positioning member may be, for example, a salt core, it is not particularly limited as long as it can be removed by being washed away with water in a subsequent step.

Next, at least a region of the molded body 6a in which the projections 13 (the recesses 14) are to be formed is heated to melt the thermoplastic resin, and a melted portion of the molded body 6a is deformed from the outer peripheral side toward the inner peripheral side, thereby forming the plurality of projections 13 (recesses 14) that project toward the inner peripheral side of the molded body 6a so as to come into contact with the component 9 (a third step). Although the projections 13 can be formed by using, for example, a forming die, the method of forming the projections 13 is not particularly limited.

Next, the molded body 6a is cooled, and the thermoplastic resin is cured again, so that the side-sill structural component 11 can be obtained (the third step). At an appropriate timing after the thermoplastic resin has been cured, the water-soluble positioning member is removed by, for example, being washed away with water.

When the recesses 14 are filled with the resin 15 (see FIG. 7), after the projections 13 have been formed in a state where the thermoplastic resin is melted, the thermoplastic resin is injected into the recesses 14 before the thermoplastic resin is cured again, and then, the thermoplastic resin is cured at the same time as the molded body 6a is cooled. As a result, the resin 15, with which the recesses 14 have been filled, and the side sill 6 can be firmly joined to each other. Alternatively, after the molded body 6a has been cooled so as to form the side-sill structural component 11, the thermoplastic resin in a molten state may be disposed in the recesses 14 and then cured by further cooling.

In the case where the energy absorption member is disposed in one or more of the recesses 14, the projections 13 are formed in a state where the thermoplastic resin is melted, and then, the energy absorption member that is made of the fiber-reinforced resin and that is molded beforehand is disposed in the one or more of the recesses 14 before the thermoplastic resin is cured again. As a result, the energy absorption member, which is disposed in the one or more of the recesses 14, and the side sill 6 can be firmly joined to each other. Alternatively, after the molded body 6a has been cooled so as to form the side-sill structural component 11, the energy absorption member may be joined to the inside of the one or more of the recesses 14 by using an adhesive or the like.

In addition, the fiber-reinforced resin layer 17 (see FIG. 8) obtained by wrapping the continuous fibers around the outer periphery of the side sill 6 and curing it with a resin may be formed. This enables the outer peripheral surface of the side-sill structural component 11 to have a seamless cylindrical closed cross section and reduces an area of the side-sill structural component 11 that are vulnerable to a collision load received by the side-sill structural component 11 during a side collision, and thus, the strength or the rigidity of the side-sill structural component 11 can be improved.

### Effects

As described above, the side-sill structural component 11 according to the present embodiment can utilize an internal space of a hollow closed cross-sectional structure formed by using the molded body 6a made of CFRP. As a result, the component 9 such as, for example, a heat exchanger provided in an electric automobile that includes a turbine generator or a hydrogen tank provided in a fuel cell vehicle can be disposed. In addition, in the side-sill structural component 11 according to the present embodiment, the component 9 disposed in the internal space is pressed and supported by the plurality of projections 13, which are formed by deforming the shape of the molded body 6a. Therefore, it is possible to obtain a structure for supporting the component 9 without breaking the fibers of the molded body 6a made of CFRP.

In addition, since the side-sill structural component 11 according to the present embodiment includes the plurality of projections 13 formed by deforming the shape of the molded body 6a, the orientation direction of the continuous fibers in the side surface portion of each of the projections 13 becomes parallel to the vehicle width direction, and the amount of energy absorbed by the side-sill structural component 11 when the side-sill structural component 11 receives the collision load during the side collision can be increased.

In addition, the side-sill structural component 11 according to the present embodiment includes the projections 13 formed only on the surface thereof on the outer side of the vehicle body in the vehicle width direction. Thus, the height of each of the projections 13 that press and support the component 9, which is disposed in the internal space, becomes largest, and the energy absorption amount when the side collision occurs can be further increased.

The side-sill structural component 11 according to the present embodiment may include the resin 15 injected into one or more of the recesses 14 that are formed on the outer peripheral side of the molded body 6a due to the plurality of projections 13. By filling one or more of the recesses 14 with the resin 15, the surface of the side sill 6 around the recesses 14 can be made flat, and a decrease in the strength or the rigidity of the side sill 6 can be suppressed. The energy absorption member may be disposed at one or more of the recesses 14. By disposing the energy absorption member in one or more of the recesses 14, the energy absorption amount when the side collision occurs can be increased.

According to the method of manufacturing the side-sill structural component 11 of the present embodiment, CFRP containing the thermoplastic resin as the matrix resin is used, so that the thermoplastic resin can be heated and melted after the molded body 6a has been mold once and the component 9 has been disposed in the internal space, and the molded body 6a can be deformed from the outside. Thus, the plurality of projections 13 capable of reliably pressing and supporting the component 9 disposed in the internal space can be easily formed. In addition, the projections 13 formed in the manner described above do not break the fibers of the molded body 6a, and thus, a decrease in the strength or the rigidity of the side sill 6 can be prevented.

Although the embodiment of the technology of the disclosure has been described in detail above with reference to the accompanying drawings, the technology of the disclosure is not limited to the above-described case. It is obvious that those who have ordinary knowledge in the technical field to which the disclosure pertains can conceive various modifications or corrections within the scope of the technical idea described in the claims, and it is to be understood that such modifications or corrections naturally pertain to the technical scope of the disclosure.

For example, in the above-described embodiment, the side-sill structural component has been described as an example of the vehicle-body structural component. However, the technology of the disclosure is not limited to the example. For example, the vehicle-body structural component may be a center-pillar structural component or a front-pillar structural component. Even in the case where the vehicle-body structural component is a center-pillar structural component or a front-pillar structural component, an internal space having a cylindrical closed cross-sectional shape can be effectively utilized, and projections that are capable of reliably supporting a component disposed in the internal space can be easily formed.

In addition, in the above-described embodiment, the projections that press and support the component are formed on a side surface in the vehicle width direction. However, the technology of the disclosure is not limited to this example. For example, the projections may be formed on both or one of upper and lower surfaces in the vehicle-body height direction. Even with such projections, projections that are capable of reliably supporting a component disposed in the internal space can be easily formed.

As described above, according to the technique of the disclosure, a vehicle-body structural component in which a predetermined component can be easily fixed in place in an internal space of a hollow molded body made of a fiber-reinforced resin and in which a decrease in the strength of the molded body can be suppressed and a method of manufacturing a vehicle-body structural component capable of efficiently manufacturing such a vehicle-body structural component can be provided.

1. A method of manufacturing a vehicle-body structural component, the method comprising:
forming a molded body that is made of a fiber-reinforced resin and that has a cylindrical shape by molding a continuous fiber impregnated with a thermoplastic resin into a cylindrical shape and curing the thermoplastic resin;
disposing a predetermined component in a space on an inner peripheral side of the molded body, which has the cylindrical shape; and
heating, while maintaining continuity of a fiber in an axial direction of the molded body and continuity of a fiber in a circumferential direction around an axis of the molded body, at least a portion of the molded body to melt the thermoplastic resin, deforming the at least a portion of the molded body that has been melted from an outer peripheral side of the molded body toward the inner peripheral side of the molded body to form projections that project toward the inner peripheral side so as to come into contact with the predetermined component, and then curing the thermoplastic resin again.

2. A method of manufacturing a vehicle-body structural component, the method comprising:
forming a molded body that is made of a fiber-reinforced resin and that has a cylindrical shape by molding a continuous fiber impregnated with a thermoplastic resin into a cylindrical shape and curing the thermoplastic resin;
disposing a predetermined component in a space on an inner peripheral side of the molded body, which has the cylindrical shape; and
heating at least a portion of the molded body to melt the thermoplastic resin, forming projections that project toward the inner peripheral side of the molded body so as to come into contact with the predetermined component, and then curing the thermoplastic resin again,
wherein the predetermined component is a heat exchanger or a hydrogen tank.

3. The method of manufacturing a vehicle-body structural component according to claim 1,
wherein the projections are formed by deforming a portion of the molded body, in which the thermoplastic resin has been melted by heating the at least a portion, from the outer peripheral side to the inner peripheral side, at least one of recesses generated in an outer peripheral surface of the molded body is filled with a resin, and then, the thermoplastic resin is cured again.

4. The method of manufacturing a vehicle-body structural component according to claim 2,
wherein the projections are formed by deforming a portion of the molded body, in which the thermoplastic resin has been melted by heating the at least a portion, from the outer peripheral side to the inner peripheral side, at least one of recesses generated in an outer peripheral surface of the molded body is filled with a resin, and then, the thermoplastic resin is cured again.

5. The method of manufacturing a vehicle-body structural component according to claim 1,
wherein the vehicle-body structural component is a side sill disposed such that the axial direction of the molded body is parallel to a longitudinal direction of a vehicle body, and
wherein the projections are provided at least on a surface of the molded body on an outer side of the vehicle body in a vehicle width direction.

6. The method of manufacturing a vehicle-body structural component according to claim 2,
wherein the vehicle-body structural component is a side sill disposed such that the axial direction of the molded body is parallel to a longitudinal direction of a vehicle body, and
wherein the projections are provided at least on a surface of the molded body on an outer side of the vehicle body in a vehicle width direction.

7. The method of manufacturing a vehicle-body structural component according to claim 5,
wherein the projections are formed by deforming a portion of the molded body, in which the thermoplastic resin has been melted by heating the at least a portion, from the outer peripheral side to the inner peripheral side, an energy absorption member is disposed at at least one of recesses generated in an outer peripheral surface of the molded body, and then, the thermoplastic resin is cured again.

8. The method of manufacturing a vehicle-body structural component according to claim 6,
wherein the projections are formed by deforming a portion of the molded body, in which the thermoplastic resin has been melted by heating the at least a portion, from the outer peripheral side to the inner peripheral side, an energy absorption member is disposed at at least one of recesses generated in an outer peripheral surface of the molded body, and then, the thermoplastic resin is cured again.

9. A vehicle-body structural component comprising:
a molded body made of a fiber-reinforced resin and having a cylindrical shape; and
a predetermined component disposed in a space inside the molded body,
wherein the molded body comprises projections provided on an inner peripheral surface of the molded body so as to come into contact with the predetermined component, the projections being configured to press and support the predetermined component, and
wherein, in the molded body, continuity of a fiber in an axial direction of the molded body and continuity of a fiber in a circumferential direction around an axis of the molded body are maintained.

10. A vehicle-body structural component comprising:
a molded body made of a fiber-reinforced resin and having a cylindrical shape; and
a predetermined component disposed in a space inside the molded body,
wherein the molded body comprises projections provided on an inner peripheral surface of the molded body so as to come into contact with the predetermined component, the projections being configured to press and support the predetermined component, and
wherein the predetermined component is a heat exchanger or a hydrogen tank.

11. The vehicle-body structural component according to claim 9,
wherein the vehicle-body structural component is a side sill disposed such that the axial direction of the molded body is parallel to a longitudinal direction of a vehicle body, and
wherein the projections are provided at least on a surface of the molded body on an outer side of the vehicle body in a vehicle width direction.

12. The vehicle-body structural component according to claim 10,
wherein the vehicle-body structural component is a side sill disposed such that the axial direction of the molded body is parallel to a longitudinal direction of a vehicle body, and
wherein the projections are provided at least on a surface of the molded body on an outer side of the vehicle body in a vehicle width direction.

13. The vehicle-body structural component according to claim 11,
wherein at least one of recesses formed on an outer peripheral side of the molded body due to the projections is provided with a resin or an energy absorption member.

14. The vehicle-body structural component according to claim 12,
wherein at least one of recesses formed on an outer peripheral side of the molded body due to the projections is provided with a resin or an energy absorption member.

15. The vehicle-body structural component according to claim 9,
wherein a matrix resin contained in the fiber-reinforced resin is a thermoplastic resin.

16. The vehicle-body structural component according to claim 10,
wherein a matrix resin contained in the fiber-reinforced resin is a thermoplastic resin.
